(19) United States
(12) Patent Application Publication
(10) Pub. No.: US 2026/0098103 A1
(43) Pub. Date: Apr. 9, 2026

(54) CELLULOSE ESTER MINERAL PARTICLE COMPOSITIONS AND METHODS OF REDUCING THE MOLECULAR WEIGHT THE CELLULOSE ESTER IN THE COMPOSITIONS THEREOF

(71) Applicant: Eastman Chemical Company, Kingsport, TN (US)

(72) Inventors: Stephanie Kay Clendennen, Kingsport, TN (US); Hamid Ebrahimi, Kingsport, TN (US); Yichen Fang, Wilmington, DE (US); Michael John Rodig, Johnson City, TN (US)

(73) Assignee: Eastman Chemical Company, Kingsport, TN (US)

(21) Appl. No.: 19/114,162

(22) PCT Filed: Sep. 21, 2023
(86) PCT No.: PCT/US2023/074777

§ 371 Date: Mar. 21, 2025

Related U.S. Application Data
(60) Provisional application No. 63/376,793, filed on Sep. 23, 2022.

(51) Int. Cl. C08B 3/06; C08B 3/16; C08B 3/18; C08K 3/34; C08K 5/103; C08L 1/10; C08L 71/02

(52) U.S. Cl. CPC C08B 3/06; C08B 3/16; C08B 3/18; C08K 3/346; C08K 5/103; C08L 1/10; C08L 71/02

(57) ABSTRACT

The present application discloses cellulose ester compositions comprising certain mineral particle compositions. The compositions when heated reduce the molecular weight of the cellulose esters in the compositions depending in the temperature, time, and mineral particle composition loading. The present application also discloses processes for reducing the molecular weight of cellulose esters in cellulose ester compositions comprising the mineral particle compositions.

### BACKGROUND

Cellulose esters (CEs) are valuable polymers that are useful in many plastic, film, coating, and fiber applications. CEs are typically synthesized by the reaction of cellulose with anhydride(s) in a solvent, hydrolyzing some ester groups to obtain a partially esterified product, and precipitating the product in a non-solvent. There are uses for both high and low molecular weight cellulose esters. Methods to lower viscosity of CE often include the presence of mineral acids and other catalysts that lower the degree of polymerization of the CE during synthesis or hydrolysis steps. That is, viscosity is modified during the process of CE synthesis and before the final precipitation. It is also desirable to be able to modify the viscosity of a CE after it has been synthesized. We have surprisingly found that a CE composition that includes an acidic mineral additive allows the CE weight average molecular weight (“M_{w}”) and thus the viscosity to be controlled during a separate compounding or other thermal processing step. The M_{w} or viscosity of the CE in the composition is controlled by the temperature and duration of the heating step, and by the loading of the acidic mineral relative to the CE.

### SUMMARY OF THE INVENTION

The present application discloses a composition, comprising:
(i) a cellulose ester;
(ii) a plasticizer; and
(iii) a mineral particle composition,
wherein when the mineral particle composition is formulated into an aqueous suspension, the aqueous suspension exhibits a pH of less than 6,
wherein:
   the plasticizer is present at from 0 to 30 wt %,
   the mineral particle composition is present at from 0.1 to 40 wt %,
   each based on the total weight of the cellulose ester composition.

The present application also discloses a process for reducing the weight average molecular weight (“Mw”) of a cellulose ester, comprising:
(1) heating a composition comprising:
   (i) the cellulose ester; and
   (ii) a mineral particle composition,
      wherein when the mineral particle composition is formulated into an aqueous suspension, the aqueous suspension exhibits a pH of less than 6,
   at a temperature of at least 200° C.,
   wherein the Mw after heating is reduced by at least 5%.

### DETAILED DESCRIPTION OF THE INVENTION

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents, printed publications, journal articles and other written text throughout this specification (referenced materials herein). Each of the referenced materials is individually incorporated herein by reference in its entirety for the referenced teaching, to the extent it does not contradict any specific teachings provided herein.

It is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

Definitions and explanations used in the present disclosure are meant and intended to be controlling in any future construction unless clearly and unambiguously modified in the example(s) or when application of the meaning renders any construction meaningless or essentially meaningless. In cases where the construction of the term would render it meaningless or essentially meaningless, the definition should be taken from Webster's Dictionary, 3rd Edition or a dictionary known to those of ordinary skill in the art.

### Composition

The present application discloses a composition, comprising: (i) a cellulose ester; (ii) a plasticizer; and (ii) a mineral particle composition, wherein when the mineral particle composition is formulated into an aqueous suspension, the aqueous suspension exhibits a pH of less than 6, wherein: the plasticizer is present at from 0 to 30 wt %, the mineral particle composition is present at from 0.1 to 40 wt %, each based on the total weight of the cellulose ester composition.

In one embodiment or in combination with any other embodiment, mineral particle composition comprises a calcined kaolin, an acidic zeolite, a bentonite, a smectite, a montmorillonite, a silica, an iron (II) oxide, a sphalerite, a pyrite, a calcined diatomaceous earth, or combinations thereof. In one class of this embodiment, the mineral particle composition comprises a calcined kaolin, an acidic zeolite, or a calcined diatomaceous earth. In one class of this embodiment, the mineral particle composition comprises calcined kaolin. In one class of this embodiment, the mineral particle composition comprises calcined diatomaceous earth.

Calcined kaolin: white kaolin clay is heat treated to remove some of its hydroxyl (OH) groups. Calcined kaolin is produced by heating ultrafine natural kaolinite to high temperatures in a kiln. The calcination process increases whiteness and hardness and alters the size and shape of the kaolin particles. Calcining temperature controls many properties, including pH of a suspension in water.

Calcined diatomaceous earth (DE) is typically treated at a temperature above 1000° C. This process changes the amorphous silica to crystalline silica. This additional thermal processing produces fundamental changes in the composition of the opaline silica frustule. Calcination dehydrates the amorphous silica in the DE and initiates its conversion to crystalline cristobalite. Thermal processing also reduces the surface area of the diatoms by altering their physical form. Calcined DE may also be acid washed to reduce color and other impurities.

In one embodiment or in combination with any other embodiment, mineral particle composition has a particle size in the range of from 0.1 microns to 200 microns, 10 microns to 50 microns, or from 10 microns to 40 microns,

In one embodiment or in combination with any other embodiment, the mineral particle composition is present at from 0.1 to 30 wt %, or from 0.1 to 20 wt %, 0.1 to 10 wt %, or from 0.1 to 8 wt %, or from 0.1 to 6 wt %, or from 0.1 to 5 wt %, or from 0.1 to 4 wt %, or from 0.1 to 3 wt %, or from 0.1 to 2 wt %, or from 0.1 to 1 wt %, 0.5 to 30 wt %, or from 0.5 to 20 wt %, 0.5 to 10 wt %, or from 0.5 to 8 wt %, or from 0.5 to 6 wt %, or from 0.5 to 5 wt %, or from 0.5 to 4 wt %, or from 0.5 to 3 wt %, or from 0.5 to 2 wt %, or from 0.5 to 1 wt %, 1 to 30 wt %, or from 1 to 20 wt %, 1 to 10 wt %, or from 1 to 8 wt %, or from 1 to 6 wt %, or from 1 to 5 wt %, or from 1 to 4 wt %, or from 1 to 3 wt %, or from 1 to 2 wt %, 2 to 30 wt %, or from 2 to 20 wt %, 2 to 10 wt %, or from 2 to 8 wt %, or from 2 to 6 wt %, or from 2 to 5 wt %, or from 2 to 4 wt %, or from 2 to 3 wt %, 3 to 30 wt %, or from 3 to 20 wt %, or from 3 to 10 wt %, or from 3 to 8 wt %, or from 3 to 6 wt %, or from 3 to 5 wt %, or from 3 to 4 wt %, 4 to 30 wt %, or from 4 to 20 wt %, 4 to 10 wt %, or from 4 to 8 wt %, or from 4 to 6 wt %, or from 4 to 5 wt %, 5 to 30 wt %, or from 5 to 20 wt %, 5 to 10 wt %, or from 5 to 8 wt %, or from 5 to 6 wt %, 6 to 30 wt %, or from 6 to 20 wt %, 6 to 10 wt %, or from 6 to 10 wt %, or from 6 to 8 wt %, 7 to 30 wt %, or from 7 to 20 wt %, or from 7 to 10 wt %, or from 7 to 8 wt %.

In one embodiment or in combination with any other embodiment, the plasticizer is present at from 0 to 30 wt %, or from 0 to 25 wt %, or from 0 to 20 wt %, or from 0 to 15 wt %, or from 0 to 10 wt %, or from 0 to 5 wt %, or from 0 to 3 wt %, or from 0 to 2 wt %, or from 0 to 1 wt %, or 0.1 to 30 wt %, or from 0.1 to 25 wt %, or from 0.1 to 20 wt %, or from 0.1 to 15 wt %, or from 0.1 to 10 wt %, or from 0.1 to 5 wt %, or from 0.1 to 3 wt %, or from 0.1 to 2 wt %, or from 0.1 to 1 wt %, or 0.5 to 30 wt %, or from 0.5 to 25 wt %, or from 0.5 to 20 wt %, or from 0.5 to 15 wt %, or from 0.5 to 10 wt %, or from 0.5 to 5 wt %, or from 0.5 to 3 wt %, or from 0.5 to 2 wt %, or from 0.5 to 1 wt %, or 1 to 30 wt %, or from 1 to 25 wt %, or from 1 to 20 wt %, or from 1 to 15 wt %, or from 1 to 10 wt %, or from 1 to 5 wt %, or from 1 to 3 wt %, or from 1 to 2 wt %, or 2 to 30 wt %, or from 2 to 25 wt %, or from 2 to 20 wt %, or from 2 to 15 wt %, or from 2 to 10 wt %, or from 2 to 5 wt %, or from 2 to 3 wt %, or 5 to 30 wt %, or from 5 to 25 wt %, or from 5 to 20 wt %, or from 5 to 15 wt %, or from 5 to 10 wt %, or 10 to 30 wt %, or from 10 to 25 wt %, or from 10 to 20 wt %, or from 10 to 15 wt %, or 15 to 30 wt %, or from 15 to 25 wt %, or from 15 to 20 wt %, or from 20 to 30 wt %, or from 20 to 25 wt %, or at 0 wt % (i.e., plasticizer free).

In one embodiment or in combination with any other embodiment, the cellulose ester is a cellulose acetate, a cellulose acetate propionate, a cellulose acetate butyrate, or a combination thereof.

In one embodiment or in combination with any other embodiment, the cellulose ester is a cellulose acetate propionate, a cellulose acetate butyrate, or a combination thereof. In one class of this embodiment, the cellulose ester is a cellulose acetate propionate. In one class of this embodiment, the cellulose ester is a cellulose acetate butyrate. In one class of this embodiment, the plasticizer is present at 0 wt % (i.e., plasticizer free). In one class of this embodiment, the plasticizer is present at from 0.1 to 10 wt %.

In one embodiment or in combination with any other embodiment, the cellulose ester is a cellulose acetate.

In one embodiment or in combination with any other embodiment, the average degree of substitution for the hydroxyl substituents (“DS_{OH}”) of the cellulose ester is from 0.5 to 0.9, or from 0.5 to 0.8, or from 0.5 to 0.7, or from 0.5 to 0.6, or from 0.6 to 0.9, or from 0.6 to 0.8, or from 0.6 to 0.7, or from 0.7 to 0.9, or from 0.7 to 0.8, or from 0.8 to 0.9.

In one embodiment or in combination with any other embodiment, when the composition is extruded with a die temperature of 200° C. with a residence time of 1 min, the weight average molecular weight loss is less than 5%, and when the composition is extruded with a die temperature of 220° C. with a residence time of 1 min, the weight average molecular weight loss is greater than 5%.

In one embodiment or in combination with any other embodiment, the composition is in the form of a pellet or a powder. In one class of this embodiment, the composition is in the form of a pellet. In one class of this embodiment, the composition is in the form of a powder.

In one embodiment or in combination with any other embodiment, the composition is in the form of a solution or a suspension or a coating. In one class of this embodiment, the composition is in the form of a solution. In one class of this embodiment, the composition is in the form of a suspension. In one class of this embodiment, the composition is in the form of a coating.

In one embodiment or in combination with any other embodiment, the plasticizer is triacetin, triethyl citrate, polyethylene glycol, Benzoflex, propylene glycol, polysorbatemsucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, glycol tribenzoate, or combinations thereof.

In one embodiment or in combination with any other embodiment, the plasticizer is tris(clorisopropyl) phosphate, tris(2-chloro-1-methylethyl) phosphate, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, an aromatic diol, a substituted aromatic diol, an aromatic ether, tripropionin, tribenzoin, a glycerin ester, glycerol acetate benzoate, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrollidinone, propylene carbonate, a C1-C20 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanolamine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, a piperidine, a piperazine, hexamethylene diamine, triazine, triazole, a pyrrole, or combinations thereof.

In one embodiment or in combination with any other embodiment, plasticizer is a biodegradable plasticizer. Some examples of biodegradable plasticizers include triacetin, tripropionin, tributyrin, tribenzoin, triglyceride mixed esters, diglycerides, soybean oil epoxides such as the Vikoflex and Paraplex™ plasticizer series; triethyl citrate, acetyl triethyl citrate; polyethylene glycol (PEG), PEG esters and PEG ethers; benzoate ester plasticizers such as the Benzoflex™ plasticizer series, sucrose ester plasticizers; dicarboxylic acid esters and polyesters (adipate based plasticizers, dibutyl sebacate); poly (alkyl succinates) such as poly (butyl succinate), polyethersulfones, polycaprolactones, the Resoflex™ and Paraplex series of polyester plasticizers, and combinations thereof.

In one embodiment or in combination with any other embodiment, wherein the plasticizer is triacetin, triethyl citrate, polyethylene glycol, Benzoflex, propylene glycol, polysorbatemsucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, glycol tribenzoate, or combinations thereof.

In one embodiment or in combination with any other embodiment, wherein the plasticizer is triacetin, triethyl citrate, Benzoflex, propylene glycol, polysorbatemsucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, glycol tribenzoate, or combinations thereof.

In one embodiment or in combination with any other embodiment, wherein the plasticizer is triacetin. In one embodiment or in combination with any other embodiment, the plasticizer is a polyethylene glycol.

In one embodiment or in combination with any of the mentioned embodiments, the cellulose acetate comprises at least one recycle cellulose acetate, wherein the cellulose acetate has at least one substituent on an anhydroglucose unit (AU) derived from recycled content material, e.g., recycled plastic content syngas.

In one embodiment or in combination with any other embodiment, the composition further comprises at least one of a filler, additive, biopolymer, stabilizer, and/or odor modifier. Examples of additives include waxes, compatibilizers, biodegradation promoters, dyes, pigments, colorants, luster control agents, lubricants, anti-oxidants, viscosity modifiers, antifungal agents, anti-fogging agents, heat stabilizers, impact modifiers, antibacterial agents, softening agents, mold release agents, and combinations thereof.

### Process

The present application discloses a process for reducing the weight average molecular weight (“Mw”) of a cellulose ester, comprising: (1) heating a composition comprising: (i) the cellulose ester; and (ii) a mineral particle composition, wherein when the mineral particle composition is formulated into an aqueous suspension, the aqueous suspension exhibits a pH of less than 6, at a temperature of at least 200° C., wherein the Mw after heating is reduced by at least 5%.

In one embodiment or in combination with any other embodiment, the heating is conducted in an extruder or a melt press. In one class of this embodiment the heating is conducted in an extruder. In one class of this embodiment, the heating is conducted in a melt press.

In one embodiment or in combination with any other embodiment, the heating is conducted at a time of from 15 seconds to 20 minutes, or from 15 seconds to 10 minutes, or from 15 seconds to 5 minutes, or from 15 seconds to 3 minutes, or from 15 seconds to 2 minutes, or from 15 seconds to 1 minute, or from 15 seconds to 50 seconds, or from 15 seconds to 40 seconds, 15 seconds to 30 seconds, or from 15 seconds to 20 seconds, or from 20 seconds to 20 minutes, or from 20 seconds to 10 minutes, or from 20 seconds to 5 minutes, or from 20 seconds to 3 minutes, or from 20 seconds to 2 minutes, or from 20 seconds to 1 minute, or from 20 seconds to 50 seconds, or from 20 seconds to 40 seconds, 20 seconds to 30 seconds, or from 30 seconds to 20 minutes, or from 30 seconds to 10 minutes, or from 30 seconds to 5 minutes, or from 30 seconds to 3 minutes, or from 30 seconds to 2 minutes, or from 30 seconds to 1 minute, or from 30 seconds to 50 seconds, or from 30 seconds to 40 seconds, or from 40 seconds to 20 minutes, or from 40 seconds to 10 minutes, or from 40 seconds to 5 minutes, or from 40 seconds to 3 minutes, or from 40 seconds to 2 minutes, or from 40 seconds to 1 minute, or from 40 seconds to 50 seconds, or from 50 seconds to 20 minutes, or from 50 seconds to 10 minutes, or from 50 seconds to 5 minutes, or from 50 seconds to 3 minutes, or from 20 seconds to 2 minutes, or from 20 seconds to 1 minute, or from 20 seconds to 50 seconds, or from 20 seconds to 40 seconds, or 20 seconds to 30 seconds.

In one embodiment or in combination with any other embodiment, the temperature is from 200° C. to 310° C., or from 200° C. to 300° C., or from 200° C. to 290° C., or from 200° C. to 280° C., or from 200° C. to 270° C., or from 200° C. to 260° C., or from 200° C. to 250° C., or from 200° C. to 240° C., or from 200° C. to 230° C., or from 200° C. to 220° C., or from 200° C. to 210° C., or 210° C. to 310° C., or from 210° C. to 300° C., or from 210° C. to 290° C., or from 210° C. to 280° C., or from 210° C. to 270° C., or from 210° C. to 260° C., or from 210° C. to 250° C., or from 210° C. to 240° C., or from 210° C. to 230° C., or from 210° C. to 220° C., or 220° C. to 310° C., or from 220° C. to 300° C., or from 220° C. to 290° C., or from 220° C. to 280° C., or from 220° C. to 270° C., or from 220° C. to 260° C., or from 220° C. to 250° C., or from 220° C. to 240° C., or from 220° C. to 230° C., or 240° C. to 310° C., or from 240° C. to 300° C., or from 240° C. to 290° C., or from 240° C. to 280° C., or from 240° C. to 270° C., or from 240° C. to 260° C., or from 240° C. to 250° C., or 250° C. to 310° C., or from 250° C. to 300° C., or from 250° C. to 290° C., or from 250° C. to 280° C., or from 250° C. to 270° C., or from 250° C. to 260° C., or 260° C. to 310° C., or from 260° C. to 300° C., or from 260° C. to 290° C., or from 260° C. to 280° C., or from 260° C. to 270° C., or 270° C. to 310° C., or from 270° C. to 300° C., or from 270° C. to 290° C., or from 270° C. to 280° C., or 280° C. to 310° C., or from 280° C. to 300° C., or from 280° C. to 290° C., or 290° C. to 310° C., or from 290° C. to 300° C.

In one embodiment or in combination with any other embodiment, the Mw after heating is reduced by at least 5%, or at least 10%, or at least 15%, or at least 20%, or at least 30%, or at least 40%, or at least 50%, or at least 60%, or at least 70%, or at least 80%, or at least 90%, or from 5% to 90%, or from 5%, to 80%, or from 5% to 70%, or from 5% to 60%, or from 5% to 50%, or from 5% to 40%, or from 5% to 30%, or from 5% to 20%, or from 5% to 15%, or from 5% to 10%, or from 10% to 90%, or from 10%, to 80%, or from 10% to 70%, or from 10% to 60%, or from 10% to 50%, or from 10% to 40%, or from 10% to 30%, or from 10% to 20%, or from 10% to 15%, or from 5% to 90%, or from 5%, to 80%, or from 5% to 70%, or from 5% to 60%, or from 15% to 50%, or from 15% to 40%, or from 15% to 30%, or from 15% to 20%, or from 20% to 90%, or from 20%, to 80%, or from 20% to 70%, or from 20% to 60%, or from 20% to 50%, or from 20% to 40%, or from 20% to 30%, or from 30% to 90%, or from 30%, to 80%, or from 30% to 70%, or from 30% to 60%, or from 30% to 50%, or from 30% to 40%, or from 40% to 90%, or from 40%, to 80%, or from 40% to 70%, or from 40% to 60%, or from 40% to 50%, or from 50% to 90%, or from 50%, to 80%, or from 50% to 70%, or from 50% to 60%, or from 60% to 90%, or from 60%, to 80%, or from 60% to 70%, or from 70% to 90%, or from 70% to 80%.

### Examples

### Abbreviations

CA is cellulose acetate; CAB is cellulose acetate butyrate, Ex is example(s); TA is triacetin; Benzoflex 50 is Eastman Benzoflex 50, PEG400 is Dow Carbowax PEG400; PEG4000 is polyethylene glycol having an average molecular weight of 4000 Da; MFR is melt flow rate; wt % is weight percent; Mw is weight average molecular weight; Mn is number average molecular weight; DE is diatomaceous earth; DA is daltons; Redtn is reduction; ° C. is degree(s) Celsius; GPC is gel permeation chromatography; rpm is revolutions per minute; min is minute(s); DS is degree of substitution.

### General Protocols

Materials: Cellulose acetate with a DS of 2.4 to 2.6 and Mw 75,000 to 120,000 (Eastman CA398-30) was used as the CA resin. Eastman CAB 381-20 was used as the cellulose mixed ester resin (Mn 70,000). Plasticizers were TA), Benzoflex 50, or Dow Carbowax PEG400 added at 10 to 20 wt %. Calcined kaolin was Burgess Optiwhite P (Burgess Pigment Company). Calcined DE used is Imerys Celite 577.

TABLE 1
Compositions

| Ex # | Composition |
|---|---|
| 1 | CA-398-30, triacetin (10 wt %) |
| 2 | CA-398-30, triacetin (10 wt %), calcined kaolin (5 wt %) |
| 3 | CA-398-30, triacetin (20 wt %), calcined kaolin (3 wt %) |
| 4 | CA-398-30, triacetin (20 wt %), calcined kaolin (5 wt %) |
| 5 | CA-398-30, PEG400 (15 wt %) |
| 6 | CA-398-30, PEG400 (15 wt %), calcined kaolin (2 wt %) |
| 7 | CA-398-30, PEG400 (15 wt %), calcined kaolin (3.5 wt %) |
| 8 | CA-398-30, PEG400 (15 wt %), calcined kaolin (5 wt %) |
| 9 | CA-398-30, PEG400 (15 wt %), calcined kaolin (10 wt %) |
| 10 | CA-394-60S, Benzoflex 50 (20 wt %), calcined kaolin (3 wt %) |
| 11 | CA-394-60S, Benzoflex 50 (20 wt %), calcined kaolin (5 wt %) |
| 12 | CAB-381-20 |
| 13 | CAB-381-20, calcined kaolin (5 wt %) |
| 14 | CA-394-60S, Triacetin (20 wt %), calcined kaolin (3 wt %) |
| 15 | CA-394-60S, Triacetin (20 wt %), calcined kaolin (5 wt %) |
| 16 | CA-398-30, PEG4000 (15 wt %), calcined kaolin (10 wt %) |
| 17 | CA-398-30, PEG4000 (15 wt %), calcined DE (10 wt %) |
| 18 | CA-398-30, PEG4000 (5 wt %), calcined kaolin (5 wt %) |
| 19 | CA-398-30, PEG400 (15 wt %), calcined kaolin (20 wt %) |
| 20 | CA-398-30, PEG400 (15 wt %), calcined kaolin (30 wt %) |
| 21 | CA-398-30, PEG400 (15 wt %), calcined kaolin (40 wt %) |

Compounding pellets: An 18 mm Leistritz twin screw extruder with a single-hole die was used to extrude pellets which were then later used for the film extrusion. These pellets were made from raw materials consisting of a CA resin powder, a plasticizer (PEG400, Benzoflex 50 or Triacetin) and optional stabilizers. Any additives other than plasticizer were added to base powder and dry-blended to produce a free-flowing powder and added to a Coperion twin-screw weight-loss feeder. The plasticizer was fed into zone 2 by a liquid injection unit accompanied by a Witte gear pump, Hardy 4060 controller, and injector with a 0.020″ bore. Typical barrel temperature ranged from 90° C. to about 225° C. at the die. Die temperature was about 200 to 240° C. Screw speed varied from 300 to 468 rpm. Compounded strands were run through a water trough and pelletized using a ConAir pelletizer.

Compression molding films: Pellets were pre-dried in an oven for about 8 h at 70 C. Films were pressed from dried pellets for a total of 4 minutes on a heated press with the upper and lower platens pre-heated to 425° F. (218° C.). The pre-dried pellets were applied to the center of a 4-inch square, 10 mil thick frame between a top and bottom layer of aluminum foil, all between two steel plates. The assembly was placed in the press and heated for 1 min at 0 pressure to dry and pre-melt the material, then pressed for 1 minute at 12,000 PHI, bumped up to higher pressure over ˜30 seconds, and finally held for 1.5 minute at 20,000 PHI (Ram force in pounds).

Extruding films: A 1.5 inch Killion single screw extruder equipped with Maddock mixer screw was utilized to produce the films. Pellets were loaded into the hopper and material passed into the barrel where the Maddock screw transferred the material toward the die. The barrel (housing the screw) is heated in three zones—pellets melt as they pass over the screw along a very narrow clearance allowing for a high shear and high degree of dispersive mixing. A homogeneous polymer mixture forms as it approaches the die and the mixture is forced through the die by the screw where extrusion occurs, forming the flat molten film as the film exits the die, it solidifies on temperature controlled polished chrome rolls (commonly known as a roll stack). Barrel temperature typically ranged from 190° C. to 240° C., with a die temperature of 230° C. to 240° C. Post extrusion the film solidifies as it cools, and samples are removed intermittently to determine film thickness. When the extruder is producing the proper film thickness the film is attached to a receiving roller and the film is carefully wound until the final roll is complete.

Gel Permeation Chromatography (GPC): The molecular weight values of CE are calculated as Polystyrene equivalent molecular weights of the test sample dissolved in Tetrahydrofuran. Samples are separated using an Agilent series 1260 Liquid chromatography system and detected by Refractive index. The mobile phase is Tetrahydrofuran stabilized with BHT. The standards are Monodisperse polystyrene ranging in molecular weight from 4,000,000 to 580 daltons.

Melt Flow Rate: The MFR values of CE are measured using an Instron semi-automatic melt flow tester at 200 C using a 2.16 kg load. Samples are dried at 60 C for 8 hours then loaded to the instrument. The volume of material extruded out of the instrument in a certain time is measured by displacement of the piston to measure Melt Volume Rate (MVR). Then the extrudate is weighed to calculate the MFR as grams per 10 minutes.

I. Compounding and Film Extrusion of CA-398-30 with Triacetin and Calcined Kaolin

Pellets were compounded as described from compositions in Table 2, and films were extruded from the compounded pellets at a nominal thickness of 30 mil. The addition of calcined kaolin (Optiwhite P) in Formula 2 made the extruded films too brittle to take up on the roll. GPC analysis showed that the resin Mw and Mn were lower in the compounded pellets containing 5 wt % calcined kaolin. Mw and Mn were further reduced after film extrusion. The Mw and Mn reductions for CA-398-30 was calculated based on the initial Mw, and Mn equal to 116,605 and 35,062 Da, respectively.

TABLE 2
Composition of pellets and corresponding
extruded films; and results of GPC

| Sample | Composition | | | | % Mn | % Mw |
|---|---|---|---|---|---|---|
| # | (Ex #) | Form | Mn | Mw | Redtn | Redtn |
| 1 | 1 | pellets | 35,438 | 90,721 | — | 22 |
| 2 | 1 | film | 37,600 | 88,967 | — | 24 |
| 3 | 2 | pellets | 28,259 | 65,863 | 19 | 44 |
| 4 | 2 | film | 9,774 | 24,648 | 72 | 79 |

II. Compounding of CA-398-30 with Polyethylene Glycol and Calcined Kaolin

Pellets were compounded as described from compositions in Table 3 and films were made using compression molding. The MFR of the pellets was measured instrument. GPC analysis showed that the resin Mw and Mn were lower in the compounded pellets containing 5 wt % calcined kaolin. Mw and Mn were further reduced after compression molding and melting under pressure to measure MFR.

TABLE 3
Composition of pellets and corresponding
extrudates; and results of GPC

| | | | | | % | % |
|---|---|---|---|---|---|---|
| Sample | Composition | | | | Mn | Mw |
| # | (Ex #) | Form | Mn | Mw | Redtn | Redtn |
| 5 | 5 | pellets | 39,262 | 96,216 | — | 17 |
| 6 | 8 | pellets | 20,840 | 57,759 | 41 | 50 |
| 7 | 8 | Compression | 20,581 | 50,379 | 41 | 57 |
| | | molded | | | | |
| | | film from | | | | |
| | | Sample 6 | | | | |
| 8 | 8 | Extrudate | 11,856 | 23,323 | 66 | 80 |
| | | from MFR | | | | |
| | | from | | | | |
| | | Sample 6 | | | | |

III. Compounding of CA-398-30 with Polyethylene Glycol and Calcined Kaolin or Calcined DE

Pellets were compounded as described from compositions in Table 4. GPC analysis showed that the resin Mw and Mn were lower in the compounded pellets containing 5 wt % calcined kaolin. Mw and Mn were further reduced when the pellets were re-compounded in the twin-screw extruder.

TABLE 4
Composition of pellets and corresponding
extruded films; and results of GPC.

| | | | | | % | % |
|---|---|---|---|---|---|---|
| Sample | Composition | | | | Mn | Mw |
| # | (Ex #) | Form | Mn | Mw | Redtn | Redtn |
| 5 | 1 | Pellets | 39,262 | 96,216 | — | 17 |
| 9 | 8 | Pellets | 20,729 | 51,747 | 41 | 56 |
| 10 | 8 | Recompounded | 16,743 | 40,231 | 52 | 65 |
| | | Sample 9 into | | | | |
| | | Pellets | | | | |
| 11 | 9 | Pellets | 20,597 | 53,002 | 41 | 55 |
| 12 | 9 | Recompounded | 17,620 | 44,194 | 50 | 62 |
| | | Sample 11 into | | | | |
| | | Pellets | | | | |

Calcined kaolin (5 wt % or 10 wt %) or calcined DE (10 wt %) were blended with plasticized CA-398-30. The calcined kaolin or calcined DE and CA-398-30 powder were sieved together twice to disperse the mineral before the plasticizer was added. The complete blends were dried for 16 h at 70° C. before pressing. Films were pressed as described, and molding conditions were as detailed in the Table 5. The CA used in this example has Mn: 32,605 kDa.

TABLE 5
Composition of compression molded films and results of GPC

| | | | | | % | % |
|---|---|---|---|---|---|---|
| Sample | Formulation | Molding | | | Mn | Mw |
| # | (Ex #) | conditions | Mn | Mw | Redtn | Redtn |
| 41 | 8 | 200° C., 3 min | 32,291 | 86,975 | 1.0 | 2.8 |
| 42 | 8 | 240° C., 3 min | 26,964 | 75,489 | 17.3 | 15.6 |
| 43 | 8 | 240° C., 6 min | 24,804 | 69,792 | 23.9 | 22.0 |
| 44 | 8 | 240° C., 9 min | 24,118 | 69,786 | 26.0 | 22.0 |
| 45 | 16 | 200° C., 3 min | 31,498 | 87,707 | 3.4 | 2.0 |
| 46 | 16 | 240° C., 3 min | 24,423 | 74,829 | 25.1 | 16.4 |
| 47 | 16 | 240° C., 6 min | 20,135 | 70,749 | 38.2 | 20.9 |
| 48 | 16 | 240° C., 9 min | 14,509 | 59,958 | 55.5 | 33.0 |
| 49 | 17 | 200° C., 3 min | 28,855 | 78,922 | 11.5 | 11.8 |
| 50 | 17 | 240° C., 3 min | 27,751 | 73,352 | 14.9 | 18.0 |
| 51 | 17 | 240° C., 6 min | 26,946 | 69,628 | 17.4 | 22.2 |
| 52 | 18 | 200° C., 3 min | 19,582 | 80,180 | 39.9 | 10.3 |
| 53 | 18 | 240° C., 3 min | 19,806 | 74,649 | 39.2 | 16.6 |
| 54 | 18 | 240° C., 6 min | 6,891 | 51,959 | 79.9 | 41.9 |

IV. Compounding of CA-398-30 with Polyethylene Glycol and Calcined Kaolin

Pellets were compounded as described from compositions in Table 6. GPC analysis showed that the resin Mw and Mn were lower in the compounded pellets containing 5 wt % calcined kaolin.

TABLE 6
Composition and compounding conditions
of pellets; and results of GPC.

| | | Die | Screw | | | % | % |
|---|---|---|---|---|---|---|---|
| Sample | Formulation | Temp | speed | | | Mn | Mw |
| # | (Ex #) | (° C.) | (rpm) | Mn | Mw | Redtn | Redtn |
| 13 | 6 | 220 | 300 | 27,197 | 65,631 | 22 | 44 |
| 14 | 6 | 220 | 468 | 23,340 | 59,749 | 33 | 49 |
| 15 | 6 | 240 | 300 | 22,681 | 55,664 | 35 | 52 |
| 16 | 6 | 240 | 468 | 18,682 | 47,675 | 47 | 59 |
| 17 | 7 | 230 | 384 | 19,949 | 50,918 | 43 | 56 |
| 18 | 8 | 220 | 300 | 23,994 | 61,750 | 32 | 47 |
| 19 | 8 | 220 | 468 | 22,178 | 60,677 | 37 | 48 |
| 20 | 8 | 240 | 300 | 19,293 | 48,370 | 45 | 59 |
| 21 | 8 | 240 | 468 | 14,267 | 35,208 | 59 | 70 |
| 55 | 19 | 240 | 468 | 17980 | 51112 | 49 | 57 |
| 56 | 20 | 240 | 468 | 13332 | 44616 | 62 | 62 |
| 57 | 21 | 240 | 468 | 12135 | 35388 | 65 | 70 |

V. Compounding CAB with Calcined Kaolin

Eastman CAB-381-20 was compounded with 5% OptiwhiteP calcined kaolin at a constant screw speed (468 rpm) at different temperatures from 200° C. to 240° C. GPC showed that calcined kaolin is effective in Mw reduction of CAB-381-20 (Table 7). The Mw and Mn reductions for CAB-381-20 was calculated based on the initial Mw, and Mn equal to 145,000 and 44,000 Da, respectively.

TABLE 7
Composition and compounding conditions
of pellets; and results of GPC.

| | | Screw | | | | % | % |
|---|---|---|---|---|---|---|---|
| Sample | Temp | speed | Formulation | | | Mn | Mw |
| # | (° C.) | (rpm) | (Ex #) | Mn | Mw | Redtn | Redtn |
| 22 | 240 | 468 | 12 | 34751 | 111330 | 21 | 23 |
| 23 | 200 | 468 | 13 | 35257 | 114603 | 20 | 21 |
| 24 | 220 | 468 | 13 | 32506 | 112121 | 26 | 23 |
| 25 | 240 | 468 | 13 | 25309 | 99038 | 42 | 32 |

VI. Compounding CA-398-30 and PEG400 without Calcined Kaolin

CA-398-30 was compounded at different screw speeds and temperatures without calcined kaolin as controls, the Mw did not drop in absence of calcined kaolin (Table 8).

TABLE 8
Composition and compounding conditions
of pellets; and results of GPC.

| | | Die | Screw | | | % | % |
|---|---|---|---|---|---|---|---|
| Sample | Formulation | Temp | speed | | | Mn | Mw |
| # | (Ex #) | (° C.) | (rpm) | Mn | Mw | Redtn | Redtn |
| 26 | 5 | 220 | 300 | 34619 | 87274 | 1 | 25 |
| 27 | 5 | 230 | 384 | 32810 | 87350 | 6 | 25 |
| 28 | 5 | 240 | 468 | 33247 | 90842 | 5 | 22 |

VII. Compounding CA-394-60S with Plasticizer and Calcined Kaolin at Low Temperature (Samples 29-32)

Pellets were compounded from formulations Ex 10, 11, 14, and 15. The dry ingredients were bag blended into a free-flowing powder. The plasticizer was fed into zone 2 by a liquid injection unit accompanied by a (Witte) gear pump, Hardy 4060 controller, and injector with a 0.020″ bore. Compounded strands were run through a water trough and pelletized (using a ConAir pelletizer). The extrusion temperature was 200° C. The molecular weights of the pellets were measured by GPC as described previously and reported in Table 9 below. With the addition of 3-5% calcined kaolin, no significant molecular weight loss was observed when the formulations were processed at 200° C.

TABLE 9
Composition and compounding conditions
of pellets; and results of GPC

| | | Die | | | % | % |
|---|---|---|---|---|---|---|
| | Formulation | Temp | | | Mn | Mw |
| Sample # | (Ex #) | (° C.) | Mn | Mw | Redtn | Redtn |
| 29 | 10 | 200 | 33350 | 89611 | 0 | 0 |
| 30 | 11 | 200 | 30941 | 87550 | 7 | 3 |
| 31 | 14 | 200 | 32516 | 85956 | 2 | 4 |
| 32 | 15 | 200 | 32931 | 89562 | 1 | 0 |

### VIII. Re-Compounding at a Higher Temperature (Materials 33-40)

The pellets produced as Samples 29-32 as described in Section VII, Table 9 were reprocessed at a higher extrusion temperature using an Xplore micro-compounder. In each run, 8 grams of compounded pellets were fed and mixed at specific temperature (220° C. or 240° C.) for specific residence time (1 min or 3 min) as described in Table 10. The molecular weights of the pellets were measured by GPC as described previously and reported in Table 10 below. The % reduction in Mn and Mw was calculated with respect to Samples 29-32. The results showed that at 220° C. and 240° C., calcined kaolin is effective in reducing molecular weight. Increasing extrusion temperature, increasing extrusion time, and increasing calcined kaolin content all led to higher degree of chain scission in the CA.

TABLE 10
Composition and compounding conditions
of pellets; and results of GPC.

| | Pellet | Die | | | | % | % |
|---|---|---|---|---|---|---|---|
| Sample | (Sample | Temp | Time | | | Mn | Mw |
| # | #) | (° C.) | (min) | Mn | Mw | Redtn | Redtn |
| 33 | 29 | 220 | 1 | 29400 | 77954 | 12 | 13 |
| 34 | 29 | 220 | 3 | 27204 | 70061 | 18 | 22 |
| 35 | 29 | 240 | 1 | 21800 | 67538 | 35 | 25 |
| 36 | 30 | 220 | 1 | 24512 | 68279 | 21 | 22 |
| 37 | 30 | 220 | 3 | 23141 | 61787 | 25 | 29 |
| 38 | 30 | 240 | 1 | 13055 | 42821 | 58 | 51 |
| 39 | 31 | 220 | 1 | 24668 | 69845 | 24 | 22 |
| 40 | 32 | 220 | 1 | 27395 | 73503 | 17 | 18 |

### IX. Melt Flow Rate of the Compounded Materials

The MFR of the pellets produced in Sections I, IV, V, and VI were measured at 220° C., 5 kg (ASTM D1238) and the results are recorded in Table 11. Samples that didn't flow are listed as MFR equal to 0.00.

TABLE 11
Composition, Compounding conditions and
Melt Flow Rate of compounded materials.

| Sample | Formulation | Compounding | |
|---|---|---|---|
| # | (Ex #) | Conditions | MFR (gr/10 min) |
| 1 | 1 | | 1.29 |
| 3 | 2 | | 32.96 |
| 13 | 6 | 220° C., 300 rpm | 14.36 |
| 14 | 6 | 220° C., 468 rpm | 18.53 |
| 15 | 6 | 240° C., 300 rpm | 22.07 |
| 16 | 6 | 240° C., 468 rpm | 28.94 |
| 17 | 7 | 230° C., 384 rpm | 37.19 |
| 18 | 8 | 220° C., 300 rpm | 39.50 |
| 19 | 8 | 220° C., 468 rpm | 62.06 |
| 20 | 8 | 240° C., 300 rpm | 64.79 |
| 21 | 8 | 240° C., 468 rpm | Too high to be measures |
| | | | at this condition |
| 22 | 12 | 240° C. | 8.89 |
| 23 | 13 | 200° C. | 20.39 |
| 24 | 13 | 220° C. | 14.47 |
| 25 | 13 | 240° C. | 21.02 |
| 26 | 5 | 220° C. | 0.00 |
| 27 | 5 | 230° C. | 0.00 |
| 28 | 5 | 240° C. | 0.00 |
| 55 | 19 | 240° C., 468 rpm | 48 |
| 56 | 20 | 240° C., 468 rpm | 67 |
| 57 | 21 | 240° C., 468 rpm | Too high to be measured |
| | | | at this condition |

1. A composition, comprising:
(i) a cellulose ester;
(ii) a plasticizer; and
(iii) a mineral particle composition,
wherein when the mineral particle composition is formulated into an aqueous suspension, the aqueous suspension exhibits a pH of less than 6,
wherein:
the plasticizer is present at from 0 to 30 wt %,
the mineral particle composition is present at from 0.1 to 40 wt %,
each based on the total weight of the cellulose ester composition.

2. The composition of claim 1, wherein the mineral particle composition comprises a calcined kaolin, an acidic zeolite, a bentonite, a smectite, a montmorillonite, iron (II) oxide, sphalerite, a pyrite, calcined diatomaceous earth, or combinations thereof.

3. The composition of claim 1, wherein the mineral particle composition comprises a calcined kaolin or calcined diatomaceous earth.

4. The composition of claim 1, wherein the mineral particle composition is present at from 0.1 to 20 wt %.

5. The composition of claim 1, wherein the plasticizer is present at from 0.1 to 30 wt %.

6. The composition of claim 1, wherein the cellulose ester is a cellulose acetate, a cellulose acetate propionate, a cellulose acetate butyrate, or a combination thereof.

7. The composition of claim 6, wherein the cellulose ester is a cellulose acetate.

8. The composition of claim 7, wherein the plasticizer is present at from 5 to 30 wt %.

9. The composition of claim 1, wherein the cellulose ester is a cellulose acetate propionate or a cellulose acetate butyrate.

10. The composition of claim 9, wherein the plasticizer is present at from 0.1 to 10 wt %.

11. The composition of claim 9, wherein the composition is plasticizer free.

12. The composition of claim 1, wherein the average degree of substitution for the hydroxyl substituents (“DS_{OH}”) of the cellulose ester is from 0.5 to 0.9.

13. The composition of claim 1, wherein when the composition is extruded with a die temperature of 200° C. with a residence time of 1 min, the weight average molecular weight loss is less than 5%, and when the composition is extruded with a die temperature of 220° C. with a residence time of 1 min, the weight average molecular weight loss is greater than 5%.

14. The composition of claim 1, in the form of a pellet or a powder.

15. A process for reducing the weight average molecular weight (“Mw”) of a cellulose ester, comprising:
(1) heating a composition comprising:
(i) the cellulose ester; and
(ii) a mineral particle composition,
wherein when the mineral particle composition is formulated into an aqueous suspension, the aqueous suspension exhibits a pH of less than 6,
at a temperature of at least 200° C.,
wherein the Mw after heating is reduced by at least 5%.

16. The process of claim 15, wherein the heating is conducted in an extruder or a melt press.

17. The process of claim 16, wherein the heating is conducted at a time of from 1 minutes to 10 minutes.

18. The composition of claim 1, wherein the plasticizer is triacetin.

19. The composition of claim 1, wherein the plasticizer is a polyethylene glycol.
